(19) United States
(12) Patent Application Publication
(10) Pub. No.: US 2025/0005765 A1
(43) Pub. Date: Jan. 2, 2025

(54) METHODS AND APPARATUS TO PROCESS IMAGES USING SEGMENTATION

(71) Applicant: Intel Corporation, Santa Clara, CA (US)

(72) Inventors: Dmitry Rudoy, Haifa (IL); Rakefet Kol, Haifa (IL); Noam Elron, Tel Aviv (IL); Noam Levy, Karmiel (IL)

(21) Appl. No.: 18/342,549

(22) Filed: Jun. 27, 2023

(51) Int. Cl. G06T 7/194; G06T 3/40; G06T 7/11

(52) U.S. Cl. CPC G06T 7/194; G06T 3/40; G06T 7/11; G06T 2207/10016; G06T 2207/20076; G06T 2207/20084

(57) ABSTRACT

Systems, apparatus, articles of manufacture, and methods are disclosed to process images using segmentation. An example apparatus includes interface circuitry, machine readable instructions, and programmable circuitry to at least one of instantiate or execute the machine readable instructions to generate a scaled frame from an input video frame, segment, with a neural network, the scaled frame to generate a scaled segmentation map based on the scaled frame, the scaled segmentation map to associate pixels of the scaled frame with ones of a plurality of segments in the scaled frame, and generate an output video frame based on the input video frame and an upscaled version of the scaled segmentation map.

### FIELD OF THE DISCLOSURE

This disclosure relates generally to computing systems and, more particularly, to methods and apparatus to process images using segmentation.

### BACKGROUND

An electronic computing device such as a laptop or a mobile device can include a camera to capture images. The camera can be used during a video call in which images of the user of the device are transmitted to other user devices.

### BRIEF DESCRIPTION OF THE DRAWINGS

FIG. 1 illustrates an example system constructed in accordance with teachings of this disclosure.

FIG. 2 is a block diagram of an example implementation of the image processing circuitry of FIG. 1.

FIGS. 3A, 3B, and 4 are example process flows to process images with the image processing circuitry of FIG. 1.

FIGS. 5 and 6 are flowcharts representative of example machine readable instructions and/or example operations that may be executed, instantiated, and/or performed by example programmable circuitry to implement the image processing circuitry 108 of FIG. 2.

FIG. 7 is a block diagram of an example processing platform including programmable circuitry structured to execute, instantiate, and/or perform the example machine readable instructions and/or perform the example operations of FIGS. 5 and 6 to implement the image processing circuitry 108 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

In an electronic computing device, such as a laptop, tablet, or smartphone that includes a camera, the device may include video conferencing applications. For example, during a video conference, the camera (e.g., a built-in video camera, a separate camera that is an accessory to the input device, imaging sensors, etc.) of the device generates images of the user. In such examples, the foreground and the background of the video may be segmented to indicate segments to be hidden and/or blurred. As used herein, “image segmentation” refers to the process of partitioning a digital image into multiple segments of sets of pixels. For example, segmentation may include determining, for each pixel of a video stream, a particular segment to which the pixel belongs. However, generating a segmented and processed image from a video stream can be time consuming, especially when the segmentation process delay the subsequent processing of the image. In some examples, a deep neural network may be trained to provide segmentation. However, image processing using delayed segmentation (including image segmentation via a neural network) can produce motion artifacts (e.g., blurred images, duplicate images, etc.) in the processed video frames. Previous solutions to improve image processing and reduce the amount of motion artifacts in a processed video frame include processing an input image prior to segmentation and other image processing techniques (e.g., Image Signal Processing Pipeline (ISP)).

Example methods and apparatus disclosed herein can improve image processing quality (e.g., color, detail, etc.) while reducing processing delay by scaling an input image approximately concurrently (e.g., within 15-30 milliseconds) with image capture to generate a scaled image for use in image segmentation. As such, some examples disclosed herein generate a scaled input frame (e.g., scaled input image) prior to segmentation of the input frame (e.g., input image). Examples disclosed herein employ a neural network to classify segments of the scaled input image. Further, examples disclosed herein utilize the scaled input image and a segmentation map to generate an output video frame (e.g., a processed video frame) and, subsequently, an output video stream (e.g., a processed video stream). Examples disclosed herein also reduce the amount of motion artifacts in output video frames and output video streams using concurrent processing of the frame and the segmentation.

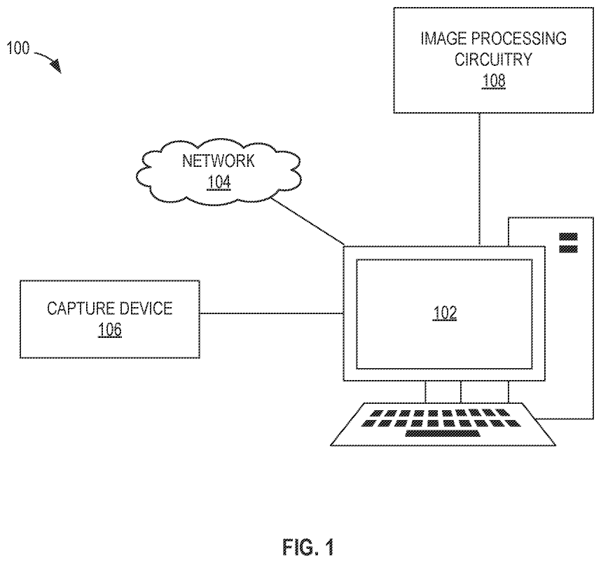

FIG. 1 illustrates an example system 100 constructed in accordance with teachings of this disclosure. The system 100 includes an example computing device 102, an example network 104, and an example capture device 106. The example computing device 102 includes example image processing circuitry 108. In this example, the computing device 102 is implemented as a desktop computer. However, in other examples, the computing device 102 can be implemented by any other type of electronic device, such as a smartphone, a tablet, a laptop computer, etc.

In the illustrated example of FIG. 1, the example system 100 includes the capture device 106. In some examples, the capture device 106 includes any kind of device and/or sensor for capturing images such as a camera, a webcam, an imaging sensor, etc. While in this example, the system 100 includes one capture device 106, in other examples, the system 100 can include any number of capture devices and/or any combination of capture devices. In some examples, one or more of the capture device 106 can be physically connected (e.g., via one or more wires or cables) and/or integral to the computing device 102. In some examples, the capture device 106 can be a discrete device that is separate from the computing device 102.

The example network 104 can be implemented by any suitable wired and/or wireless network(s) including, for example, one or more data buses, one or more Local Area Networks (LANs), one or more wireless LANs, one or more cellular networks, one or more public networks, etc. The example network 104 enables transmission of data (e.g., audio data) between the devices 102, 106, for example.

In FIG. 1, the computing device 102 includes the image processing circuitry 108. The example image processing circuitry 108 accesses input image data (e.g., input images, raw images, input video frames, video streams, etc.) from the capture device 106 via at least one of the network 104 or the computing device 102. In some examples, the image processing circuitry 108 accesses the input image data from the capture device 106 via sensor serial interfaces. Further, the example image processing circuitry 108 implements image segmentation and processing in accordance with examples disclosed herein to process the input image data to generate an output image (e.g., processed image, processed video frame, processed video stream, etc.). The example image processing circuitry 108 can be operatively coupled to other image processing systems (e.g., ISP algorithms, segmentation algorithms, temporal noise reduction (TNR) algorithms, NN(s), etc.).

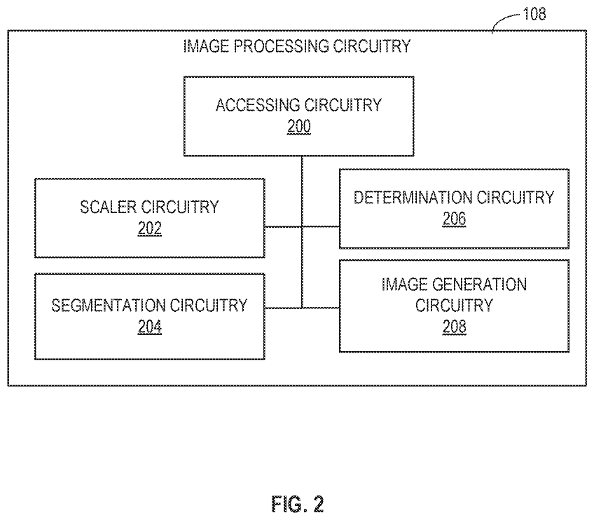

FIG. 2 is a block diagram of an example implementation of the image processing circuitry 108 of FIG. 1 to access input image data from the capture device 106 and implement image segmentation and processing of the input image data in accordance with examples disclosed herein. The example image processing circuitry 108 includes example accessing circuitry 200, example scaler circuitry 202, segmentation circuitry 204, example priority determination circuitry 206, and example frame generation circuitry 208. The image processing circuitry 108 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the image processing circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

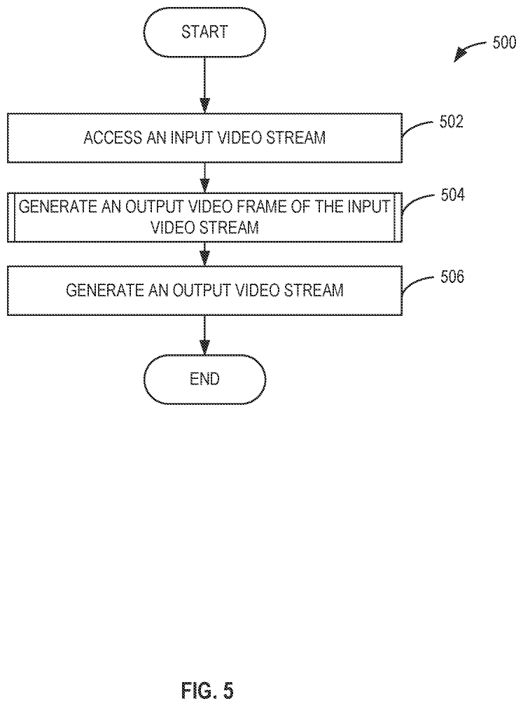

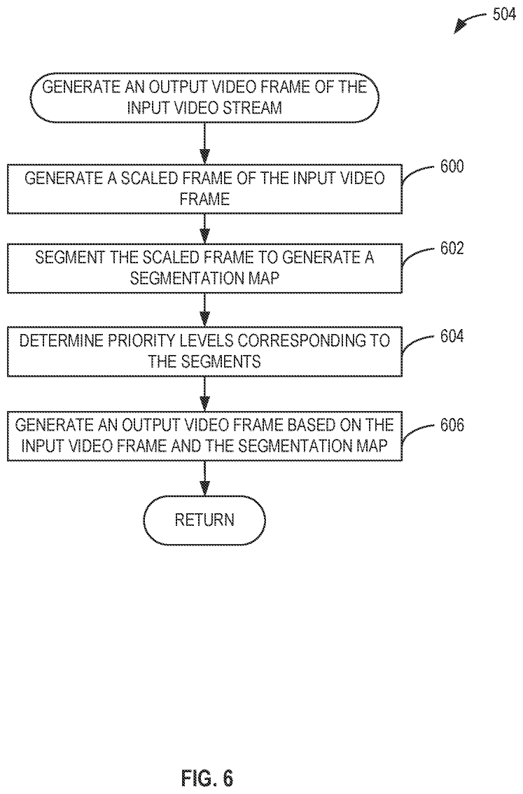

The example accessing circuitry 200 accesses an input video stream (e.g., video stream, raw video stream, etc.). In some examples, the accessing circuitry 200 is communicatively coupled to the example capture device 106, wherein the capture device 106 captures the input video stream. In some examples, the accessing circuitry 200 can access at least one input video frame in the input video stream. For example, the accessing circuitry 200 can monitor an input video stream for an input video frame. In some examples, the input video frame is an initial (e.g., first, beginning, start, etc.) video frame in the input video stream. In some examples, the accessing circuitry 200 is instantiated by programmable circuitry executing accessing instructions and/or configured to perform operations such as those represented by the flowcharts of FIGS. 5 and 6.

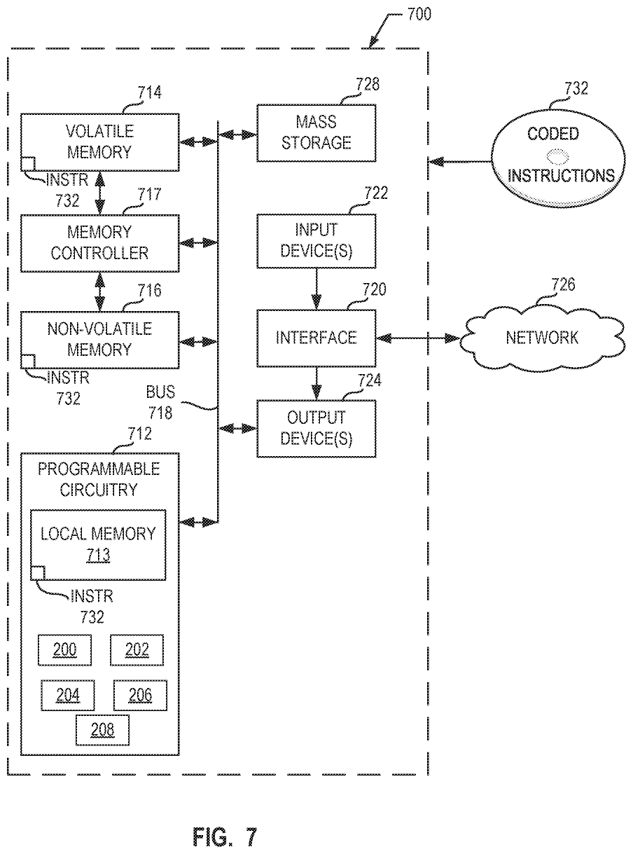

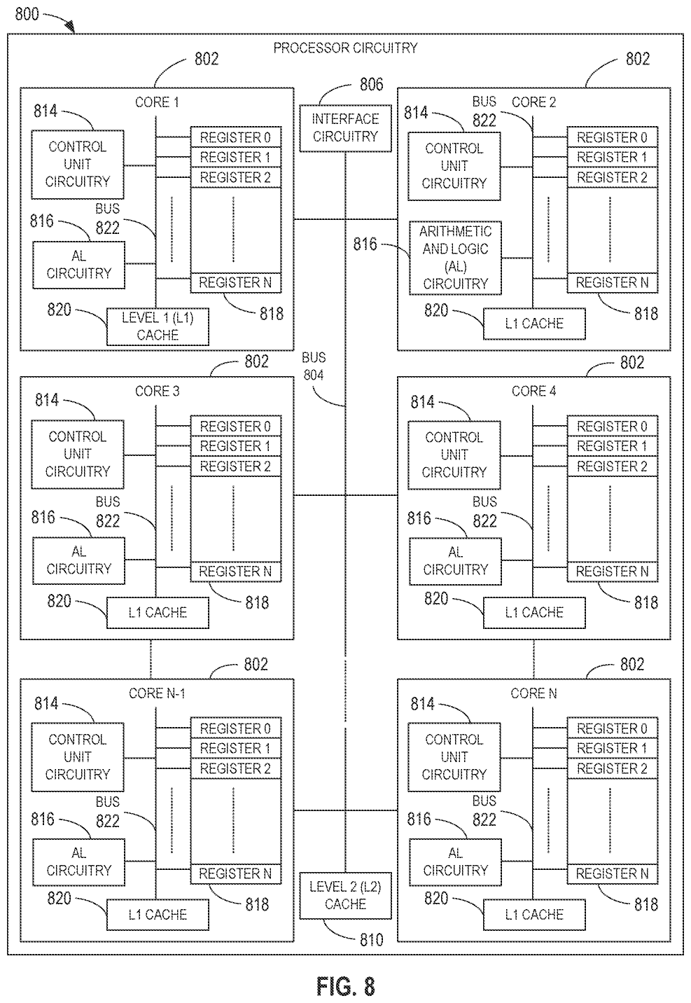

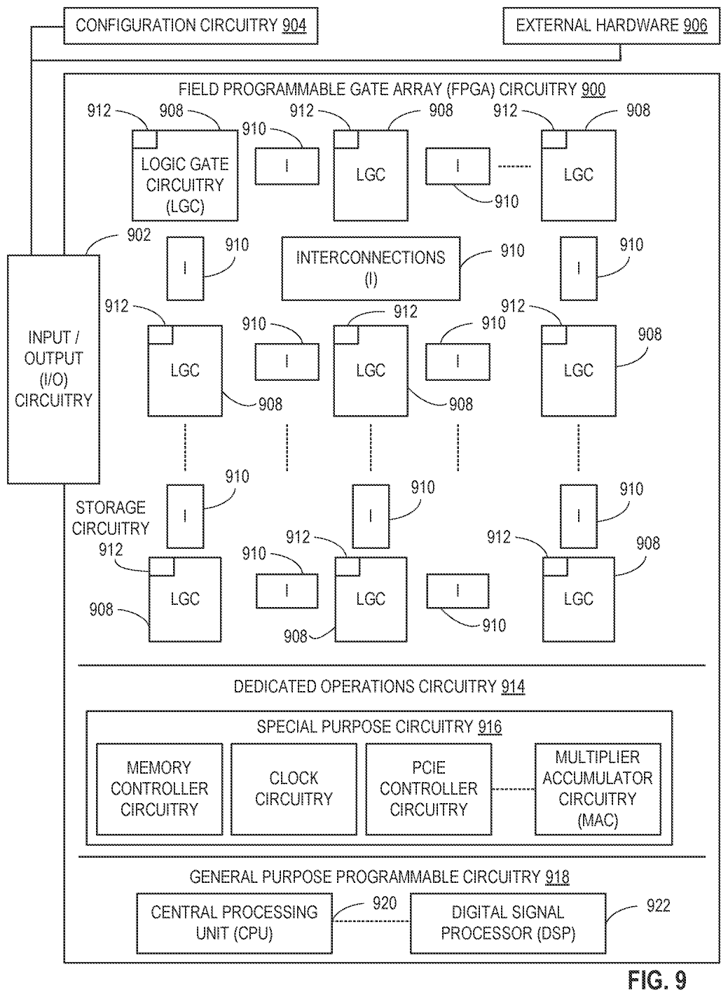

In some examples, the image processing circuitry 108 includes means for accessing an input video stream. For example, the means for accessing may be implemented by accessing circuitry 200. In some examples, the accessing circuitry 200 may be instantiated by programmable circuitry such as the example programmable circuitry 712 of FIG. 7. For instance, the accessing circuitry 200 may be instantiated by the example microprocessor 800 of FIG. 8 executing machine executable instructions such as those implemented by at least blocks 502 of FIG. 5. In some examples, the accessing circuitry 200 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the accessing circuitry 200 may be instantiated by any other combination of hardware, software, and/or firmware. For example, the accessing circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example scaler circuitry 202 generates a scaled frame (e.g., scaled image) from the input video frame by, for example, downsampling the input video frame to a lower resolution using any appropriate downsampling technique (e.g., binning, bilinear downsampling, bicubic downsampling, etc.). The example scaled frame has a smaller data size than the input video frame. In such examples, the smaller data size of the scaled frame enables quicker, more efficient segmentation compared to the lengthier process of segmenting a raw input video frame having a larger data size. As such, power and bandwidth savings can result from segmentation of the scaled frame. Further, the smaller data size of the scaled frame allows for more precise segmentation based on a better understanding of the entire input video stream. In some examples, the scaler circuitry 202 generates the scaled frame for the input video frame before or concurrent with (e.g., in parallel with) the next (e.g., subsequent) video frame being captured. In some examples, the scaler circuitry 202 is instantiated by programmable circuitry executing scaling instructions and/or configured to perform operations such as those represented by the flowcharts of FIGS. 5 and 6.

In some examples, the image processing circuitry 108 includes means for scaling an input video frame. For example, the means for scaling may be implemented by scaler circuitry 202. In some examples, the scaler circuitry 202 may be instantiated by programmable circuitry such as the example programmable circuitry 712 of FIG. 7. For instance, the scaler circuitry 202 may be instantiated by the example microprocessor 800 of FIG. 8 executing machine executable instructions such as those implemented by at least blocks 600 of FIG. 6. In some examples, the scaler circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the scaler circuitry 202 may be instantiated by any other combination of hardware, software, and/or firmware. For example, the scaler circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example segmentation circuitry 204 segments the scaled frame. In some examples, the segmentation circuitry 204 segments the scaled frame with a segmentation neural network (NN). The example segmentation NN can be trained using training data that may include reference images of typical scenes associated with a particular capture device (e.g., the capture device 106). As such, the example segmentation NN is trained to recognize common features between the training data and the example scaled frame. In some examples, the common features correspond to example segments in the scaled frame. In some examples, the segmentation circuitry 204 generates a first segmentation map based on the scaled frame. In some examples, the first segmentation map associates pixels of an input video frame with ones of a plurality of segments (e.g., classes, classifications, etc.) determined for the scaled frame. For example, the first segmentation map associates a first pixel of the input frame with a first segment of the scaled frame, a second pixel of the input frame with a second segment of the scaled frame, etc. In some examples, the first segmentation map includes confidence values associated with the pixels. For example, the first segmentation map associates the first pixel of the input video frame with a first confidence value, the second pixel of the input video frame with a second confidence value, etc. In some examples, the confidence values indicate probabilities that the pixels correspond to the associated (e.g., assigned, predicted, etc.) segments. For example, a first confidence value may indicate a first probability (e.g., 80%) that a first pixel of the input video frame corresponds (e.g., belongs) to a first segment of the scaled frame, a second confidence value may indicate a second probability that a second pixel of the input video frame corresponds to a second segment of the scaled frame, etc. In some examples, the example confidence values indicate similarity between the segments in the scaled frame and the training data associated with the segmentation NNs. In some examples, the segments are objects in the input video frame. In some examples, the segments can include a foreground segment (e.g., a moving subject) of the input video frame and a background segment (e.g., background static segment) of the input video frame. In some examples, the segmentation circuitry 204 is instantiated by programmable circuitry executing segmentation instructions and/or configured to perform operations such as those represented by the flowcharts of FIGS. 5 and 6.

In some examples, the image processing circuitry 108 includes means for segmenting a scaled frame. For example, the means for segmenting may be implemented by segmentation circuitry 204. In some examples, the segmentation circuitry 204 may be instantiated by programmable circuitry such as the example programmable circuitry 712 of FIG. 7. For instance, the segmentation circuitry 204 may be instantiated by the example microprocessor 800 of FIG. 8 executing machine executable instructions such as those implemented by at least blocks 602 of FIG. 6. In some examples, the segmentation circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the segmentation circuitry 204 may be instantiated by any other combination of hardware, software, and/or firmware. For example, the segmentation circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example priority determination circuitry 206 determines priority levels (e.g., weights) corresponding to the segments. In some examples, the priority determination circuitry 206 can determine priority levels based on a relative importance of one segment compared to another with respect to the content being conveyed by the image frame. For example, a first segment (e.g., a foreground segment or a particular object (e.g., person, thing, etc.) of the foreground segment) in the input video frame may be more important (e.g., relevant) than a second segment (e.g., a background segment) to the content being conveyed by the input video frame. Accordingly, the priority determination circuitry 206 can determine a first priority level corresponding to the first segment and a second priority level corresponding to the second segment, wherein the first priority level (e.g., 1) is greater than the second priority level (e.g., 0). In some examples, the example priority levels are values in a range from 0 to 1, with 0 corresponding to the lowest priority and 1 corresponding to the highest priority. In some examples, the resolution of an example output video frame may be based on the priority levels corresponding to the segments. For example, first output pixels of the output video frame can be associated with the first segment and the first priority level and second output pixels of the output video frame can be associated with the second segment and the second priority level. Accordingly, the first output pixels of the first segment can be flagged or otherwise identified for downstream processing at a higher resolution (e.g., better quality resolution) than the second output pixels of the second segment based on the first priority level being greater than the second priority level. In some examples, the priority determination circuitry 206 is instantiated by programmable circuitry executing priority determination instructions and/or configured to perform operations such as those represented by flowcharts of FIGS. 5 and 6.

In some examples, the image processing circuitry 108 includes means for determining priority levels of segments. For example, the means for determining may be implemented by priority determination circuitry 206. In some examples, the priority determination circuitry 206 may be instantiated by programmable circuitry such as the example programmable circuitry 712 of FIG. 7. For instance, the priority determination circuitry 206 may be instantiated by the example microprocessor 800 of FIG. 8 executing machine executable instructions such as those implemented by at least blocks 604 of FIG. 6. In some examples, the priority determination circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the priority determination circuitry 206 may be instantiated by any other combination of hardware, software, and/or firmware. For example, the priority determination circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example frame generation circuitry 208 generates an example output video frame. In some examples, the frame generation circuitry 208 generates the output video frame via at least one of an ISP algorithm or a TNR algorithm. In some examples, the frame generation circuitry 208 generates the output video frame based on the input video frame and a segmentation map. In some examples, the frame generation circuitry 208 is instantiated by programmable circuitry executing frame generation instructions and/or configured to perform operations such as those represented by flowcharts of FIGS. 5 and 6.

In some examples, the image processing circuitry 108 includes means for generating an output video frame. For example, the means for generating may be implemented by frame generation circuitry 208. In some examples, the frame generation circuitry 208 may be instantiated by programmable circuitry such as the example programmable circuitry 712 of FIG. 7. For instance, the frame generation circuitry 208 may be instantiated by the example microprocessor 800 of FIG. 8 executing machine executable instructions such as those implemented by at least blocks 506 of FIG. 5 and 606 of FIG. 6. In some examples, the frame generation circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the frame generation circuitry 208 may be instantiated by any other combination of hardware, software, and/or firmware. For example, the frame generation circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

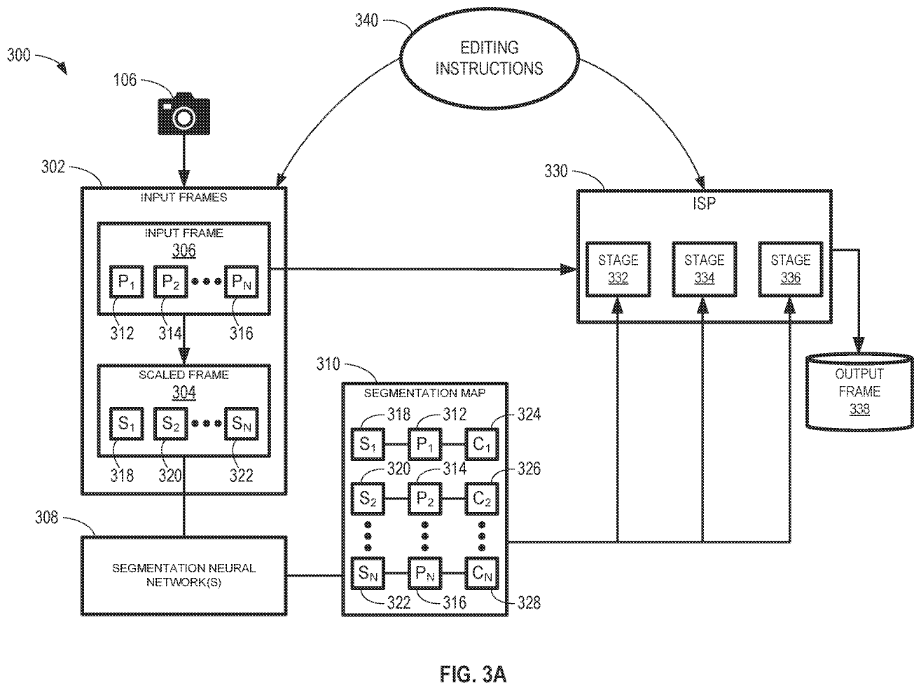

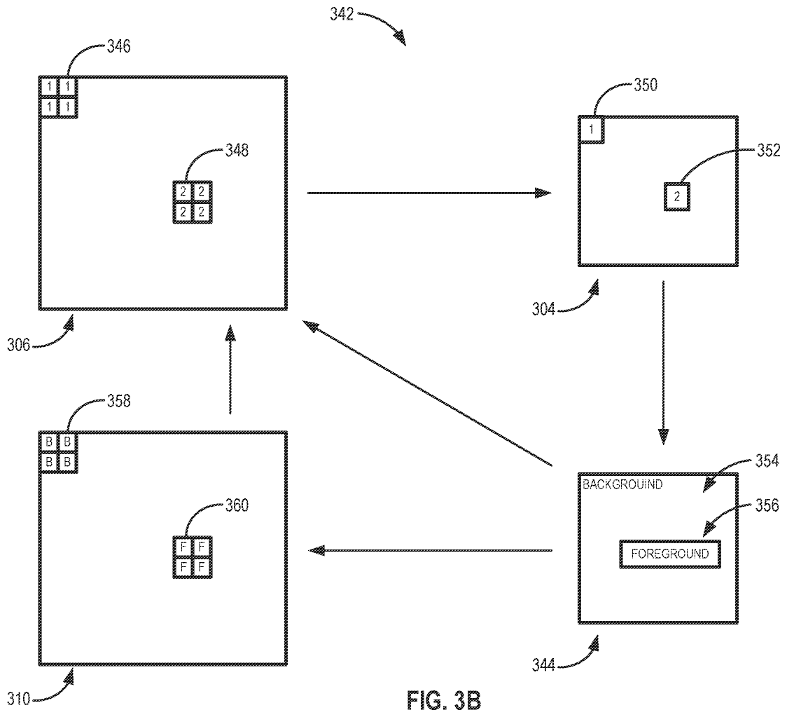

FIG. 3A illustrates an example process flow 300 that may be implemented by the example image processing circuitry 108. The example process flow 300 begins operation as the example capture device 106 captures an example input video stream. In the example of FIG. 3A, the input video stream includes example input video frames 302 for subsequent processing. In some examples, the accessing circuitry 200 is communicatively coupled to the capture device 106 to access the input video stream and input video frames 302 of the input video stream. Further, the example scaler circuitry 202 generates an example scaled frame 304 from a first example input video frame 306 of the input video frames 302. In some examples, the scaler circuitry 202 generates the scaled frame 304 for the input video frame 306 before or concurrent with (e.g., in parallel with) the next video frame being captured.

Next, one or more example segmentation NN(s) 308 access the scaled frame 304. In some examples, the segmentation NN(s) 308 are implemented by the segmentation circuitry 204. The example segmentation circuitry 204 generates an example segmentation map 310 (e.g., a first segmentation map) associated with the scaled frame 304. In some examples, the segmentation map 310 associates pixels 312, 314, 316 of the input video frame 306 with ones of a plurality of segments 318, 320, 322 in the scaled frame 304. For example, the segmentation map 310 associates the first segment 318 of the scaled frame 304 with the first pixel 312 of the input video frame 306, the second segment 320 of the scaled frame 304 with the second pixel 314 of the input video frame 306, the nth segment 322 of the scaled frame 304 with the nth pixel 316 in the input video frame 306, etc. In some examples, the first segmentation map 310 includes confidence values 324, 326, 328 associated with the pixels 312, 314, 316. For example, the segmentation map 310 associates the first pixel 312 of the input video frame 306 with a first example confidence value 324, the second pixel 314 of the input video frame 306 with a second example confidence value 326, the nth pixel 316 of the input video frame 306 with an nth example confidence value 328, etc. In some examples, the confidence values 324, 326, 328 indicate probabilities that the pixels 312, 314, 316 correspond to the associated segments 318, 320, 322. For example, the first confidence value 324 indicates a first probability that the first pixel 312 corresponds to the first segment 318, the second confidence value 326 indicates a second probability that the second pixel 314 corresponds to the second segment 320, the nth confidence value 328 indicates an nth probability that the nth pixel 316 corresponds to the nth segment 322, etc. In some examples, the segmentation circuitry 204 generates a second example segmentation map that is a compressed version of the first example segmentation map 310.

In the illustrated example of FIG. 3A, an example ISP pipeline 330 accesses the input video frame 306 and the segmentation map 310. The example ISP pipeline 330 may include example algorithm stages 332, 334, 336 for processing of the input video frames 302 of the input video stream. In some examples, the ISP pipeline 330 is implemented by the frame generation circuitry 208 to generate an example output video frame 338. As such, the example frame generation circuitry 208 can generate an example output video stream of the input video stream based on the output video frame 338. The example algorithm stages 332, 334, 336 can access the segmentation map 310 to incorporate the segment-pixel pairings and corresponding confidence values 324, 326, 328 in image processing procedures. In some examples, the frame generation circuitry 208 can include example editing instructions 340 to execute other image processing operations (e.g., black level (BL) correction, white balance (WB) processing, cropping, scaling, etc.).

FIG. 3B illustrates an example process flow 342 to implement the example image processing circuitry 108. The example process flow 342 includes the input frame 306, the scaled frame 304, a scaled segmentation map 344, and the segmentation map 310 (e.g., upscaled segmentation map 310). In the example of FIG. 3B, the input frame 306 includes a first group (e.g., cluster) of pixels 346 (e.g., the pixels 312, 314, 316) and a second group of pixels 348. In some examples, the image processing circuitry 108 can associate and/or group pixels in the input frame 306 based on like/similar attributes (e.g., color, brightness, movement, shape, etc.) and/or location within the frame (e.g., left corner, center, etc.). In this example, the input frame 306 includes two groups of pixels 346, 348. However, the input frame 306 can include any number of groups of pixels. The example image processing circuitry 108 generates the scaled frame 304 based on the input frame 306. In this example, the input frame 306 is scaled (e.g., down-sampled) by a factor of 4. In other words, the scaled frame 304 includes a first example pixel 350 representative of the group of four pixels 346 in the input frame 306 and a second example pixel 352 representative of the group of four pixels 348 in the input frame. As such, the example image processing circuitry 108 can scale the input frame 306 based on corresponding ones of similar pixels and an example scale factor (e.g., 4, 8, etc.).

The example segmentation NN(s) 308 generate the scaled segmentation map 344 based on the scaled frame 304. The example scaled segmentation map 344 includes two segments, an example background segment 354 and an example foreground segment 356. In some examples, the segmentation NN(s) 308 determine a segment that each of the pixels 350, 352 of the scaled frame 304 corresponds to based on location and/or movement associated with the pixels 350, 352. For example, the outer edges of the scaled frame 304 are likely associated with background information of the input image 306 and the center of the scaled frame 304 is likely associated with relevant/important information of the input image 306. In some examples, the image processing circuitry 108 can determine confidence values to represent that likelihood (e.g., 80% likely that the pixel 350 located near the edge of the scaled frame 304 corresponds to the background segment 354). Accordingly, the example segmentation NN(s) 308 can segment the scaled frame 304 based on positions of the pixels 350, 352 with respect to each other and/or with respect to the edges of the scaled frame 304.

In some examples, the segmentation NN(s) 308 can perform segmentation based on movement detected in the scaled frame 304. For example, when the segmentation NN(s) 308 detect movement (e.g., movement of a subject, a person, etc.) in a region of the scaled frame 304 including the pixel 352, the segmentation NN(s) 308 can determine that the pixel 352 includes relevant/important information and thus should be associated with the foreground segment 356. Additionally, if the segmentation NN(s) 308 detects lack of or little movement in a region of the scaled frame 304 including the pixel 350, the segmentation NN(s) 308 can determine that the pixel 350 includes background information and thus should be associated with the background segment 354. In some examples, the image processing circuitry 108 can determine confidence values to represent that likelihood (e.g., 80% likely that the pixel 352 is associated with movement corresponding to the foreground segment 356).

The example image processing circuitry 108 can implement the scaled segmentation map 344 by generating the upscaled segmentation map 310 (e.g., an upscaled version of the scaled segmentation map 344). For example, the image processing circuitry 108 can upscale the scaled segmentation map 344 by a scale factor of 4 (to reverse the down-sampling associated with the scaled segmentation map 344 and yield an up-scaled map that matches the pixel count/resolution of the input frame 306). As such, the example upscaled segmentation map 310 includes a third group of four pixels 358 corresponding to the position of the pixel 350 in the background segment 354 and a fourth group of four pixels 360 corresponding to the position of the pixel 352 in the foreground segment 356. Further, the pixels 358, 360 in the upscaled segmentation map 310 correspond to the pixels 346, 348 at the same locations of the input image 306. The example image processing circuitry 108 can generate a processed version of the input frame 306 based on the upscaled segmentation map 310.

In some examples, the example image processing circuitry 108 can implement the scaled segmentation map 344 by applying the scaled segmentation map 344 to the input frame 306 with an intermediate up-scaling operation. For example, the image processing circuitry 108 can determine, based on the down-sampling used to generate the scaled frame 304, that the location of the group of pixels 346 corresponds to the scaled location of the background segment 354. Further, the image processing circuitry 108 can determine, based on the down-sampling used to generate the scaled frame 304, that the location of the group of pixels 348 corresponds to the scaled location of the foreground segment 356. When the example image processing circuitry 108 determines that the pixels 346 correspond to the background segment 354 and that the pixels 348 correspond to the foreground segment 356, the image processing circuitry 108 can use segment specific processing instructions to process the input frame 306. For example, the image processing circuitry 108 may process the pixels 348 of the foreground segment 356 differently than the pixels 346 of the background segment 354. The image processing circuitry 108 can deblur, apply black level correction, denoise, etc., the pixels 348 of the foreground segment 356 (to emphasize important information) and can blur or shade the pixels 346 of the background segment 354.

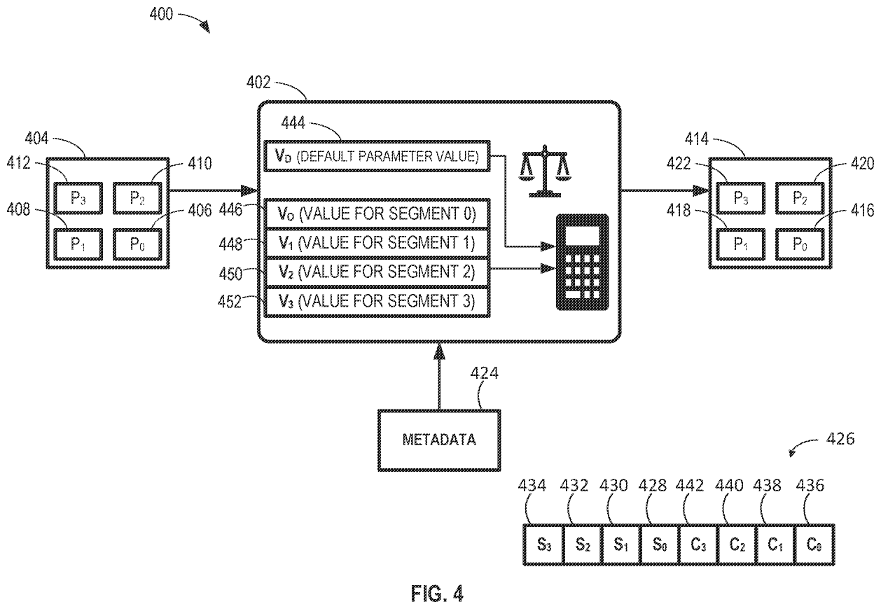

FIG. 4 illustrates another example process flow 400 that can be implemented by the example image processing circuitry 108. The example process flow 400 utilizes an example algorithm stage 402 that can access an example input video frame 404 having input pixels 406, 408, 410, 412 and produce an example output video frame 414 having output pixels 416, 418, 420, 422. In this example, the example input video frame 404 includes four input pixels 406, 408, 410, 412. However, the example input video frame 404 can include any number of pixels. Additionally, the example output video frame 414 includes four output pixels 416, 418, 420, 422. However, the example output video frame 414 can include any number of pixels. In some examples, the stage 402 corresponds to at least one of the algorithm stages 332, 334 and/or 336 of FIG. 3A. However, the stage 402 can also be implemented by the example image processing circuitry 108.

In the illustrated example of FIG. 4, an example stage 402 accesses the input pixels 406, 408, 410, 412 and example metadata 424. The example metadata 424 includes data pertaining to an example segmentation map 426. In this example, the segmentation circuitry 204 generates the segmentation map 426 based on an example scaled frame of the input video frame 404 (similar to the scaled frame 304 of FIGS. 3A and 3B). The example segmentation map 426 includes example segment assignments 428, 430, 432, 434 and example confidence values 436, 438, 440, 442 that indicate probabilities that the input pixels 406, 408, 410, 412 correspond to the segments 428, 430, 432, 434. For example, the confidence value C₃ 442 indicates a probability that the pixel P₃ 412 corresponds to the segment S₃ 434, the confidence value C₂ 440 indicates a probability that the pixel P₂ 410 corresponds to the segment S₂ 432, the confidence value C₁ 438 indicates a probability that the pixel P₁ 408 corresponds to the segment S₁ 430, and the confidence value C₀ 436 indicates a probability that the pixel P₀ 406 corresponds to the segment S₀ 428.

The example stage 402 can represent an example calculation/process to convert the input pixels 406, 408, 410, 412 into output pixels 416, 418, 420, 422 using the metadata 424 and example parameter values 444, 446, 448, 450, 452. In some examples, the parameter value 444 can be a default parameter value (V_{D}). The example parameter values 446, 448, 450, 452 can vary based on the corresponding segments. For example, the parameter value V₀ 446 corresponds to segment S₀ 428, the parameter value V₁ 448 corresponds to segment S₁ 430, the parameter value V₂ 450 corresponds to segment S₂ 432, the parameter value V₃ 452 corresponds to segment S₃ 434. In some examples, a weighted sum of the default parameter value 444 and at least one of the parameter values 446, 448, 450, 452 can be used to generate the output pixels 416, 418, 420, 422. In the illustrated example, there are four parameter values 446, 448, 450, 452 corresponding to each of the segments 428, 430, 432, 434. However, there can be any number of parameter values based on the number of segments identified in a scaled frame of the example input video frame 404. In other examples, the number of parameter values is independent (e.g., different) from the number of segments.

The example stage 402 can prioritize certain segments for processing/generation of the output video frame 414. For example, the priority determination circuitry 206 can determine that segment S₂ 432 includes the highest priority level compared to any of the segments 428, 430, 434. Accordingly, in some such examples, the stage 402 can process the input pixel P₂ 410 using V₂ 450, S₂ 432, and C₂ 440 to generate the output pixel P₂ 420 without performing processing techniques (e.g., denoising, deblurring, etc.) on the other pixels 406, 408, 410 to preserve time, computing power, etc. In some examples, the segment S₂ 432 may correspond to a head of a person in the input video frame 404. In some examples, the priority determination circuitry 206 can determine that first ones of the segments (e.g., S₂ 432 and S₃ 434) include higher priority levels than second ones of the segments (e.g., S₀ 428 and S₁ 430). In some such examples, the stage 402 can process the input pixel P₂ 410 using V₂ 450, S₂ 432, and C₂ 440 and input pixel P₃ 412 using V₃ 452, S₃ 434, and C₃ 442 to generate the output pixels P₂ 420 and P₃ 422, respectively, without performing computations on the other pixels 406, 408 to preserve time, computing power, etc.

Example equation 1, which is provided below, represents an example formula to generate a parameter value (Vₚ) for processing an example pixel (pₙ).

$$( {C}_{n} * {V}_{n} ) + ( 1 - {C}_{n} ) * {V}_{D} = {V}_{p}$$

In example equation 1 above, the example parameter value (Vₚ) to process an example pixel (pₙ) is determined by the confidence value (Cₙ) of the pixel (pₙ) multiplied by the parameter value (Vₙ) of the given segment into which the pixel (pₙ) has been segmented plus the default parameter value (V_{D}) multiplied by 1 minus the confidence value (Cₙ).

While an example manner of implementing the image processing circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example accessing circuitry 200, the example scaler circuitry 202, the example segmentation circuitry 204, the example priority determination circuitry 206, the example frame generation circuitry 208, and/or, more generally, the example image processing circuitry 108 of FIG. 2, may be implemented by hardware alone or by hardware in combination with software and/or firmware. Thus, for example, any of the example accessing circuitry 200, the example scaler circuitry 202, the example segmentation circuitry 204, the example priority determination circuitry 206, the example frame generation circuitry 208, and/or, more generally, the example image processing circuitry 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example image processing circuitry 108 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the image processing circuitry 108 of FIG. 2 and/or representative of example operations which may be performed by programmable circuitry to implement and/or instantiate the image processing circuitry 108 of FIG. 2, are shown in FIGS. 5 and 6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and 6, many other methods of implementing the example image processing circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to process an input video stream. The example machine-readable instructions and/or the example operations 500 of FIG. 5 begin at block 502, at which the accessing circuitry 200 accesses an example input video stream. In some examples, the accessing circuitry 200 is communicatively coupled to the capture device 106, wherein the capture device 106 captures the input video stream. In some examples, the accessing circuitry 200 can access at least one input video frame (e.g., the input video frame 306, the input video frame 404, etc.) in the input video stream. For example, the accessing circuitry 200 can monitor an input video stream for an input video frame. In some examples, the input video frame is an initial (e.g., first, beginning, start, etc.) video frame in the input video stream.

At block 504, the example image processing circuitry 108 generates an output video frame of an input video frame in the input video stream, as described in detail in connection with FIG. 6.

At block 506, the example frame generation circuitry 208 generates an output video stream. For example, the frame generation circuitry 208 generates an output video stream of the input video stream based on the output video frame (e.g., the output video frame 338, the output video frame 414, etc.). Then, the process ends.

FIG. 6 is a flowchart representative of example machine readable instructions and/or example operations that may be executed, instantiated, and/or performed by programmable circuitry to implement the image processing circuitry 108, as described above in connection with block 504 of FIG. 5. The example machine readable instructions and/or the operations of FIG. 6 begin at block 600, at which the example scaler circuitry 202 generates a scaled frame of an example input video frame (e.g., the input video frame 306, the input video frame 404, etc.). In some examples, the scaler circuitry 202 generates the scaled frame 304 for the input video frame 306 before or concurrent with (e.g., in parallel with) the next video frame being captured. In some examples, the scaler circuitry 202 generates the scaled frame 304 of the input frame 306 based on a down-sampling factor of 4 or some other value.

At block 602, the example segmentation circuitry 204 segments the scaled frame. In some examples, the segmentation circuitry 204 generates the scaled segmentation map 344 based on the scaled frame 304. In some examples, the segmentation circuitry 204 generates the segmentation map 426 to associate input pixels 406, 408, 410, 412 of the input video frame 404 with ones of the segments 428, 430, 432, 434 in the scaled frame of the input video frame 404. For example, the segmentation circuitry 204 associates the pixel P₀ 406 with the segment S₀ 428, the pixel P₁ 408 with the segment S₁ 430, the pixel P₂ 410 with the segment S₂ 432, and the pixel P₃ 412 with the segment S₃ 434. Further, the segmentation circuitry 204 can determine the confidence value C₃ 442 (indicating a probability that the pixel P₃ 412 corresponds to the segment S₃ 434), the confidence value C₂ 440 (indicating a probability that the pixel P₂ 410 corresponds to the segment S₂ 432), the confidence value C₁ 438 (indicating a probability that the pixel P₁ 408 corresponds to the segment S₁ 430), and the confidence value C₀ 436 (indicating a probability that the pixel P₀ 406 corresponds to the segment S₀ 428).

At block 604, the example priority determination circuitry 206 determines priority levels corresponding to the example segments (e.g., the segments 318, 320, 322, the segments 428, 430, 432, 434). For example, the priority determination circuitry 206 can determine that first ones of the segments (e.g., S₂ 432 and S₃ 434) include higher priority levels than second ones of the segments (e.g., S₀ 428 and S₁ 430). In some examples, the foreground segment 356 may have a higher priority level than the background segment 354 because the foreground segment 356 includes more relevant/important information (e.g., a person, a subject, etc.) of the input frame 306.

At block 606, the example frame generation circuitry 208 generates an output video frame based on the input video frame and the segmentation map. For example, the frame generation circuitry 208 generates the output video frame 338 based on the input video frame 306 and the segmentation map 310. Further, the example frame generation circuitry 208 generates the output video frame 414 based on the input video frame 404 and the segmentation map 426. Additionally or alternatively, the example frame generation circuitry 208 can generate the example output video frame using compressed versions of the segmentation map 310 and/or the segmentation map 426. In some examples, the frame generation circuitry 208 can generate the output pixels 416, 418, 420, 422 of the output video frame 414. In some examples, the frame generation circuitry 208 can generate an example output video frame based on priority levels of the example segments. For example, when the priority determination circuitry 206 determines that first ones of the segments (e.g., S₂ 432 and S₃ 434) include higher priority levels than second ones of the segments (e.g., S₀ 428 and S₁ 430), the frame generation circuitry 208 can generate the output pixels P₂ 420 and P₃ 422 without performing computations on the other input pixels 406, 408 to preserve time, computing power, etc. In other words, the frame generation circuitry 208 takes less time and uses less computing power to process 2 pixels (e.g., P₂ 420 and P₃ 422) than the frame generation circuitry 208 would need to process 4 pixels (P₀ 416, P₁ 418, P₂ 420 and P₃ 422). Then, the process returns to block 506 in FIG. 5.

FIG. 7 is a block diagram of an example programmable circuitry platform 700 structured to execute and/or instantiate the example machine-readable instructions and/or the example operations of FIGS. 5 and 6 to implement the image processing circuitry 108 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example accessing circuitry 200, the example scaler circuitry 202, the example segmentation circuitry 204, the example priority determination circuitry 206, and the example frame generation circuitry 208.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video).

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and 6. As such, the FPGA circuitry 900 may be configured and/or structured to effectively instantiate some or all of the operations/functions corresponding to the machine readable instructions of the flowchart(s) of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and 6, and/or an ASIC may be configured and/or structured to perform third operation(s)/function(s) corresponding to a third portion of the machine readable instructions represented by the flowcharts of FIGS. 5 and 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

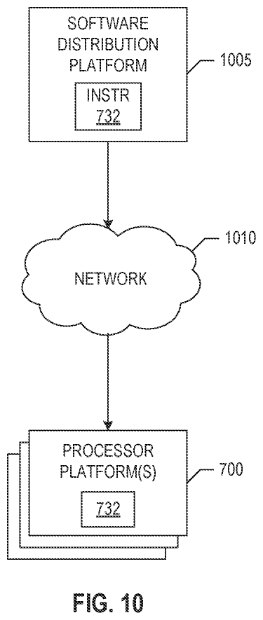

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and 6, may be downloaded to the example programmable circuitry platform 700, which is to execute the machine readable instructions 732 to implement the image processing circuitry 108. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that improve image processing quality by scaling an input image approximately concurrently (e.g., within 2 seconds) with image capture. As such, examples disclosed herein can generate a scaled input frame prior to segmentation of the input frame. Further, examples disclosed herein utilize the scaled input image and a scaled segmentation map to generate an output video frame and, subsequently, an output video stream. Disclosed systems, apparatus, articles of manufacture, and methods improve the efficiency of using a computing device by reducing the amount of computing power necessary to generate processed video frames associated with an input video stream. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine readable instructions, and programmable circuitry to at least one of instantiate or execute the machine readable instructions to generate a scaled frame from an input video frame, segment, with a neural network, the scaled frame to generate a scaled segmentation map based on the scaled frame, the scaled segmentation map to associate pixels of the scaled frame with ones of a plurality of segments in the scaled frame, and generate an output video frame based on the input video frame and an upscaled version of the scaled segmentation map.

Example 2 includes the apparatus of example 1, wherein the segmentation map includes confidence values associated with the pixels, the confidence values representative of probabilities that ones of the pixels correspond to the at least one of the segments.

Example 3 includes the apparatus of example 1, wherein one or more of the segments correspond to objects in the input video frame.

Example 4 includes the apparatus of example 1, wherein the segments include a first segment and a second segment, and the programmable circuitry is to determine a first priority level corresponding to the first segment and a second priority level corresponding to the second segment, the first priority level greater than the second priority level.

Example 5 includes the apparatus of example 4, wherein first output pixels of the output video frame are associated with the first segment and second output pixels of the output video frame are associated with the second segment, the first output pixels associated with a higher resolution than the second output pixels.

Example 6 includes the apparatus of example 4, wherein the first segment is a foreground segment of the input video frame and the second segment is a background segment of the input video frame.

Example 7 includes the apparatus of example 1, wherein the programmable circuitry is to access the input video frame from an input video stream, access a subsequent video frame from the input video stream, and generate the scaled frame before the subsequent video frame is accessed.

Example 8 includes the apparatus of example 1, wherein the programmable circuitry is to generate an output video stream based on the output video frame.

Example 9 includes the apparatus of example 1, wherein the programmable circuitry is to access the input video frame from an input video stream, access a subsequent video frame from the input video stream, and generate the scaled frame concurrently with access of the subsequent video frame.

Example 10 includes At least one non-transitory computer readable medium comprising instructions to cause programmable circuitry to at least generate a scaled frame from an input video frame, segment, with a neural network, the scaled frame to generate a scaled segmentation map based on the scaled frame, the scaled segmentation map to associate pixels of the scaled frame with ones of a plurality of segments in the scaled frame, and generate an output video frame based on the input video frame and an upscaled version of the scaled segmentation map.

Example 11 includes the at least one non-transitory computer readable medium of example 10, wherein the segmentation map includes confidence values associated with the pixels, the confidence values representative of probabilities that ones of the pixels correspond to the at least one of the segments.

Example 12 includes the at least one non-transitory computer readable medium of example 10, wherein one or more of the segments correspond to objects in the input video frame.

Example 13 includes the at least one non-transitory computer readable medium of example 10, wherein the segments include a first segment and a second segment, and the instructions cause the programmable circuitry to determine a first priority level corresponding to the first segment and a second priority level corresponding to the second segment, the first priority level greater than the second priority level.

Example 14 includes the at least one non-transitory computer readable medium of example 13, wherein a first output pixel of the output video frame is associated with the first segment and a second output pixel of the output video frame is associated with the second segment, the first output pixel associated with a higher resolution than the second output pixel.

Example 15 includes the at least one non-transitory computer readable medium of example 14, wherein the first segment is a foreground segment of the input video frame and the second segment is a background segment of the input video frame.

Example 16 includes the at least one non-transitory computer readable medium of example 10, wherein the instructions cause the programmable circuitry to access the input video frame from an input video stream, access a subsequent video frame from the input video stream, and generate the scaled frame before the subsequent video frame is accessed.

Example 17 includes the at least one non-transitory computer readable medium of example 10, wherein the instructions cause the programmable circuitry to generate an output video stream based on the output video frame.

Example 18 includes the at least one non-transitory computer readable medium of example 10, wherein the instructions cause the programmable circuitry to access the input video frame from an input video stream, access a subsequent video frame from the input video stream, and generate the scaled frame concurrently with access of the subsequent video frame.

Example 19 includes an apparatus comprising means for scaling an input video frame, means for segmenting, with a neural network, the scaled frame to generate a scaled segmentation map based on the scaled frame, the scaled segmentation map to associate pixels of the scaled frame with ones of a plurality of segments in the scaled frame, and means for generating an output video frame based on the input video frame and an upscaled version of the scaled segmentation map.

Example 20 includes the apparatus of example 19, wherein the segmentation map includes confidence values associated with the pixels, the confidence values representative of probabilities that ones of the pixels correspond to the at least one of the segments.

Example 21 includes the apparatus of example 19, wherein one or more of the segments correspond to objects in the input video frame.

Example 22 includes the apparatus of example 19, wherein the segments include a first segment and a second segment, further including means for determining to determine a first priority level corresponding to the first segment and a second priority level corresponding to the second segment, the first priority level greater than the second priority level.

Example 23 includes the apparatus of example 22, wherein a first output pixel of the output video frame is associated with the first segment and a second output pixel of the output video frame is associated with the second segment, the first output pixel associated with a higher resolution than the second output pixel.

Example 24 includes the apparatus of example 22, wherein the first segment is a foreground segment of the input video frame and the second segment is a background segment of the input video frame.

Example 25 includes the apparatus of example 19, further including means for accessing to access the input video frame from an input video stream, and access a subsequent video frame from the input video stream, and the means for scaling to generate the scaled frame before the subsequent video frame is accessed.

Example 26 includes the apparatus of example 19, wherein the means for generating is to generate an output video stream based on the output video frame.

Example 27 includes the apparatus of example 19, further including means for accessing to access the input video frame from an input video stream, and access a subsequent video frame from the input video stream, and the means for scaling to generate the scaled frame concurrently with access of the subsequent video frame.

Example 28 includes a method comprising generating a scaled frame of an input video frame, segmenting, with a neural network, the scaled frame to generate a scaled segmentation map based on the scaled frame, the scaled segmentation map to associate pixels of the scaled frame with ones of a plurality of segments in the scaled frame, and generating an output video frame based on the input video frame and an upscaled version of the scaled segmentation map.

Example 29 includes the method of example 28, wherein the segmentation map includes confidence values associated with the pixels, the confidence values representative of probabilities that ones of the pixels correspond to the at least one of the segments.

Example 30 includes the method of example 28, wherein one or more of the segments correspond to objects in the input video frame.

Example 31 includes the method of example 28, wherein the segments include a first segment and a second segment, further including determining a first priority level corresponding to the first segment and a second priority level corresponding to the second segment, the first priority level greater than the second priority level.

Example 32 includes the method of example 31, wherein a first output pixel of the output video frame is associated with the first segment and a second output pixel of the output video frame is associated with the second segment, the first output pixel associated with a higher resolution than the second output pixel.

Example 33 includes the method of example 31, wherein the first segment is a foreground segment of the input video frame and the second segment is a background segment of the input video frame.

Example 34 includes the method of example 28, further including accessing the input video frame from an input video stream, accessing a subsequent video frame from the input video stream, and generating the scaled frame before the subsequent video frame is accessed.

Example 35 includes the method of example 28, further including generating an output video stream based on the output video frame.

Example 36 includes the method of example 28, further including accessing the input video frame from an input video stream, accessing a subsequent video frame from the input video stream, and generating the scaled frame concurrently with access of the subsequent video frame.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine readable instructions; and
programmable circuitry to at least one of instantiate or execute the machine readable instructions to:
generate a scaled frame from an input video frame;
segment, with a neural network, the scaled frame to generate a scaled segmentation map based on the scaled frame, the scaled segmentation map to associate pixels of the scaled frame with ones of a plurality of segments in the scaled frame; and
generate an output video frame based on the input video frame and an upscaled version of the scaled segmentation map.

2. The apparatus of claim 1, wherein the segmentation map includes confidence values associated with the pixels, the confidence values representative of probabilities that ones of the pixels correspond to the at least one of the segments.

3. The apparatus of claim 1, wherein one or more of the segments correspond to objects in the input video frame.

4. The apparatus of claim 1, wherein the segments include a first segment and a second segment, and the programmable circuitry is to determine a first priority level corresponding to the first segment and a second priority level corresponding to the second segment, the first priority level greater than the second priority level.

5. The apparatus of claim 4, wherein first output pixels of the output video frame are associated with the first segment and second output pixels of the output video frame are associated with the second segment, the first output pixels associated with a higher resolution than the second output pixels.

6. The apparatus of claim 4, wherein the first segment is a foreground segment of the input video frame and the second segment is a background segment of the input video frame.

7. The apparatus of claim 1, wherein the programmable circuitry is to:
access the input video frame from an input video stream;
access a subsequent video frame from the input video stream; and
generate the scaled frame before the subsequent video frame is accessed.

8. The apparatus of claim 1, wherein the programmable circuitry is to generate an output video stream based on the output video frame.

9. The apparatus of claim 1, wherein the programmable circuitry is to:
access the input video frame from an input video stream;
access a subsequent video frame from the input video stream; and
generate the scaled frame concurrently with access of the subsequent video frame.

10. At least one non-transitory computer readable medium comprising instructions to cause programmable circuitry to at least:
generate a scaled frame from an input video frame;
segment, with a neural network, the scaled frame to generate a scaled segmentation map based on the scaled frame, the scaled segmentation map to associate pixels of the scaled frame with ones of a plurality of segments in the scaled frame; and
generate an output video frame based on the input video frame and an upscaled version of the scaled segmentation map.

11. The at least one non-transitory computer readable medium of claim 10, wherein the segmentation map includes confidence values associated with the pixels, the confidence values representative of probabilities that ones of the pixels correspond to the at least one of the segments.

12. The at least one non-transitory computer readable medium of claim 10, wherein one or more of the segments correspond to objects in the input video frame.

13. The at least one non-transitory computer readable medium of claim 10, wherein the segments include a first segment and a second segment, and the instructions cause the programmable circuitry to determine a first priority level corresponding to the first segment and a second priority level corresponding to the second segment, the first priority level greater than the second priority level.

14. The at least one non-transitory computer readable medium of claim 13, wherein a first output pixel of the output video frame is associated with the first segment and a second output pixel of the output video frame is associated with the second segment, the first output pixel associated with a higher resolution than the second output pixel.

15. The at least one non-transitory computer readable medium of claim 14, wherein the first segment is a foreground segment of the input video frame and the second segment is a background segment of the input video frame.

16. The at least one non-transitory computer readable medium of claim 10, wherein the instructions cause the programmable circuitry to:
access the input video frame from an input video stream;
access a subsequent video frame from the input video stream; and
generate the scaled frame before the subsequent video frame is accessed.

17. The at least one non-transitory computer readable medium of claim 10, wherein the instructions cause the programmable circuitry to generate an output video stream based on the output video frame.

18. The at least one non-transitory computer readable medium of claim 10, wherein the instructions cause the programmable circuitry to:
access the input video frame from an input video stream;
access a subsequent video frame from the input video stream; and
generate the scaled frame concurrently with access of the subsequent video frame.

19-36. (canceled)
